(19) United States
(12) Patent Application Publication
(10) Pub. No.: US 2016/0256804 A1
(43) Pub. Date: Sep. 8, 2016

(54) STRAINING AND TRANSPORT SYSTEM AND METHOD FOR USING THE SAME

(71) Applicant: ROYALTY PROS LICENSING, LLC, OSSINING, NY (US)

(72) Inventor: ANNA MEDEIROS, OSSINING, NY (US)

(73) Assignee: ROYALTY PROS LICENSING, LLC, OSSINING, NY (US)

(21) Appl. No.: 15/057,730

(22) Filed: Mar. 1, 2016

Related U.S. Application Data
(60) Provisional application No. 62/127,819, filed on Mar. 3, 2015.

(51) Int. Cl. B01D 35/28; A47J 43/24

(52) U.S. Cl. CPC B01D 35/28; A47J 43/24

(57) ABSTRACT

A straining and transport system includes an extending flexible net system and an entrained drawing loop string for use in a catchment basin having a drain, An additional central basket portion may be integrated centrally into the net system proximate the drain and may be separately removable. The entrained drawing loop string is entrained with the net system about an outer perimeter portion so that during a tensioned use, the loop string gathers the perimeter portion together forming an encircling loop and securing any use debris in the flexible net system for removal from catchment basin. Other aspects of the invention include the use of rigid or semi-rigid portions replacing all or a portion of the net system and movable relative to a central portion for support. Additionally the net may include a retaining basket portion proximate the drain for additional catchment.

### CROSS REFERENCE TO RELATED APPLICATIONS

This application relates to and claims priority from U.S. Prov. Ser. No. 62/127,819 filed Mar. 3, 2015, the entire contents of which are included by reference.

### FIGURE SELECTED FOR PUBLICATION

FIG. 2

### BACKGROUND OF THE INVENTION

1. Field of the Invention

The present invention relates to straining and storing system and method for using the same. More particularly, the present invention provides a convenient and adaptable straining apparatus and method for improving catchment of debris.

2. Description of the Related Art

Industrial applications of straining devices include the use of rigid-form strainers for cooking and draining of cooked materials. Also known in the industry are the use large flexible netting systems for either safety retaining and barriers or the catching of deep water fish.

Further known in the industry are commercial sink drain-hole covers with rigid covers typically with a number of small openings wherein the cover additionally serves as a drain-plug and is recessed relative to the inner bottom level of the sink itself so as to not interfere with the draining of fluid along the downward slope of the sink itself. Additionally, such rigid sink drain-hole covers are also necessarily safety requirements for the use of below-sink garbage disposal and debris grinding devices. Such devices may optionally also serve as the triggering switch mechanism for the grinding devices.

Unfortunately, during common sink usage for food preparation involves the passage of a large number of unusually shaped debris (e.g., chopped vegetable parts) which may be either small (below 1 centimeter in largest length) or rather large (up to 10 centimeters or more of largest length). These different sizes intermix and can prevent water passage to the drain. As an additional result. during known usages these debris are swept into the sink and typically rest on the lower sink surface forming a large mass that must be removed from the sink by grasping fingers for separate disposal or recycling or using such fingers, pushed downward into the drain itself risking injury.

Accordingly, there is a need for an improved straining and transport system and method for using the same.

### ASPECTS AND SUMMARY OF THE INVENTION

In response, it is now recognized that the present invention provides a straining and transport system includes an extending flexible net system and an entrained drawing loop string for use in a catchment basin having a drain. An additional central basket portion may be integrated centrally into the net system proximate the drain. The entrained drawing loop string is entrained with the net system about an outer perimeter portion so that during a tensioned use, the loop string gathers the perimeter portion together forming an encircling loop and securing any use debris in the flexible net system for removal from catchment basin. Other aspects of the invention include the use of rigid or semi-rigid portions replacing the net system and movable relative to a central portion for support. Additionally the net may include a retaining basket portion proximate the drain for additional catchment.

According to one alternative aspect of the present invention, there is provided a straining and transport system comprising: a net material member having an outer perimeter boundary; a draw loop system entrained in said net material member proximate said outer perimeter boundary, and said draw loop system being slidably therealong relative to said net material member whereby during a pulling use of said draw loop system said entrained net material is gathered relative to a central portion thereof.

According to another alternative aspect of the present invention, there is provided a straining and transport system, further comprising: a plurality of supporting structures removably engaging selected portions of said net material relative to upright walls of an external catchment basin so that during said pulling use, said net material is removable relative to said upright walls for easy transport.

According to another alternative aspect of the present invention, there is provided a straining and transport system, further comprising: said supporting structures including suction cup members operable for a suction-based securement to said upright walls.

According to another alternative aspect of the present invention, there is provided a straining and transport system, further comprising: a respective engagement hook member extending from each said suction cup member for removably engaging with said net material.

According to another alternative aspect of the present invention, there is provided a straining and transport system, wherein: said net material is at least one of a woven material and a molded material: and said net material includes a plurality of small openings operable to allow a fluid passage and retainment of debris prior to removal from said external catchment basin.

According to another alternative aspect of the present invention, there is provided a straining and transport system, further comprising: a mesh basket portion proximate said central portion of said net material, whereby during said use said mesh basket portion is removably retained proximate a draining opening in said catchment basin.

According to another alternative aspect of the present invention, there is provided a straining and transport system, further comprising: a plurality of leaf portions proximate replacing said net material and flexible therebetween during said use.

According to another alternative aspect of the present invention, there is provided a straining and transport system, further comprising: a mesh basket portion proximate said central portion of said plurality of leaf portions, whereby during said use said mesh basket portion is removably retained proximate a draining opening in said catchment basin.

According to another alternative aspect of the present invention, there is provided a method for straining and transporting waste members relative to a catchment basin, comprising the steps of: providing a net material member having an outer perimeter boundary; providing a draw loop system entrained in said net material member proximate said outer perimeter boundary; said draw loop system being slidably therealong relative to said net material member during a pulling use whereby during said pulling use of said draw loop system said entrained net material is gathered relative to a central portion thereof; securing a plurality of removable supporting structures and engaging selected portions of said net material on said removable supporting structures relative to upright walls of said external catchment basin so that during said pulling use, said net material is removable relative to said upright walls for easy transport; whereby said supporting structures further include suction cup members operable for a suction-based securement to said upright walls; and providing respective engagement hook member extending from each said suction cup member for removably engaging with said net material.

According to another alternative aspect of the present invention, there is provided a method for straining and transporting waste members relative to a catchment basin, further comprising the steps of: providing said net material as one of a woven material and a molded material; and said net material includes a plurality of small openings operable to allow a fluid passage and retainment of external debris prior to removal from said external catchment basin.

According to another alternative aspect of the present invention, there is provided a method for straining and transporting waste members relative to a catchment basin, further comprising the steps of: providing a mesh basket portion proximate said central portion of said net material, whereby during said use said mesh basket portion is removably retained proximate a draining opening in said catchment basin.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a top pictographic view of one embodiment of the net system as a catchment device for securing debris during a use.

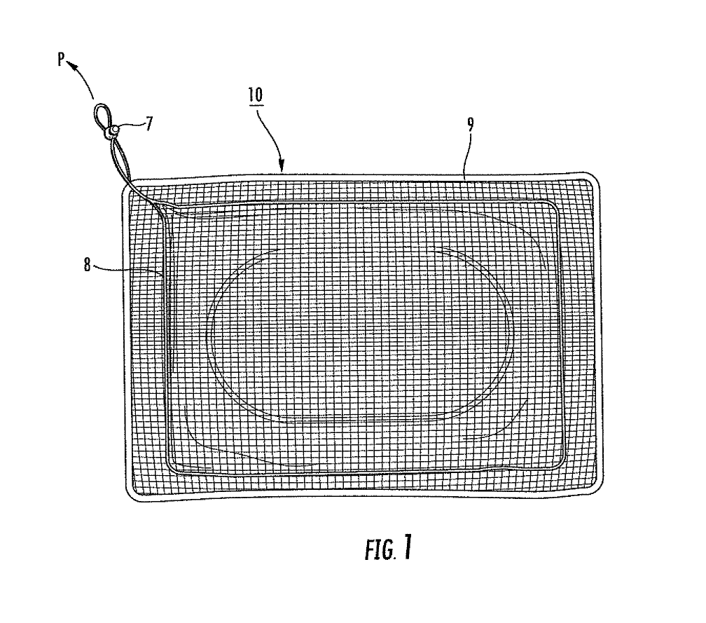

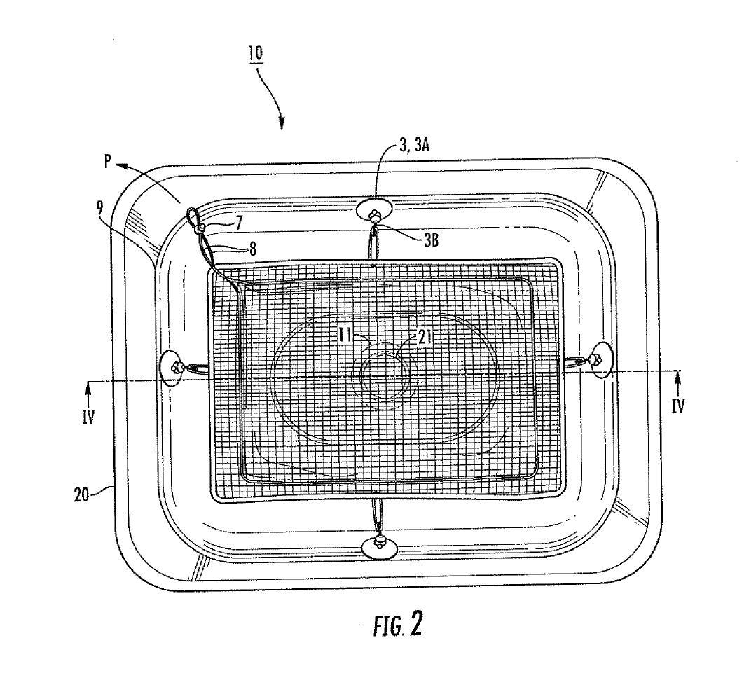

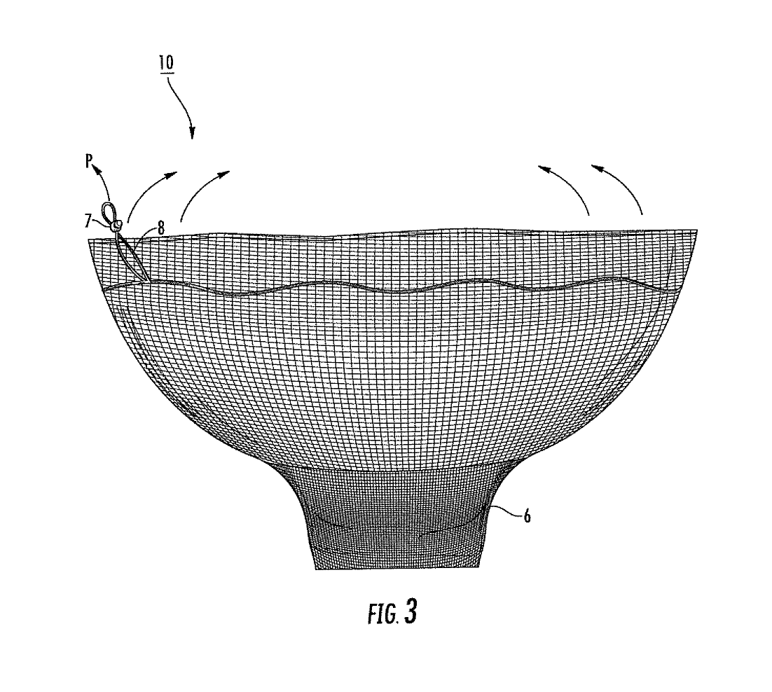

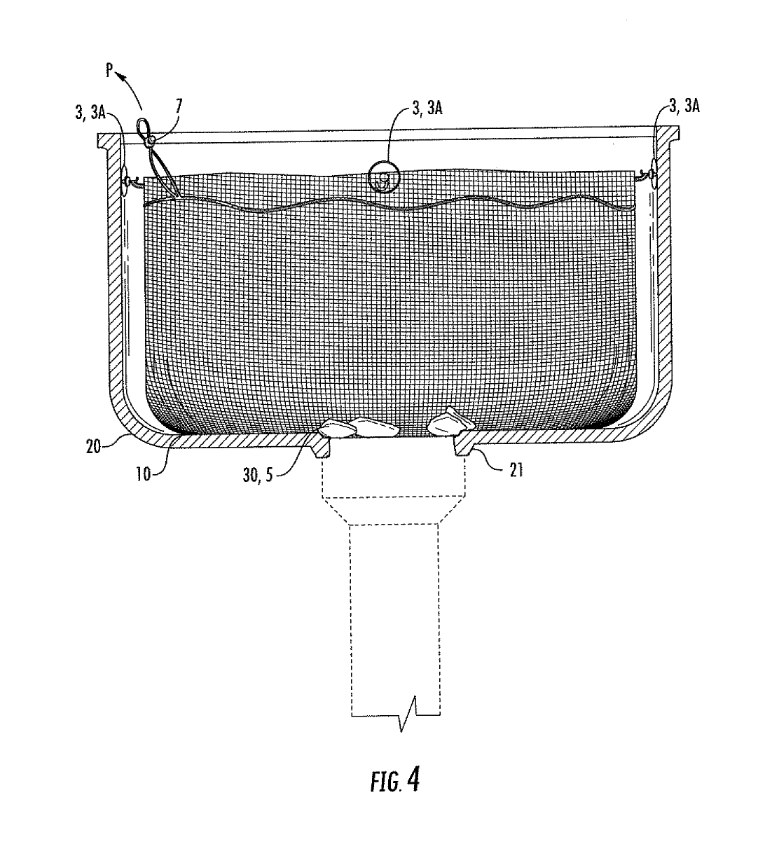

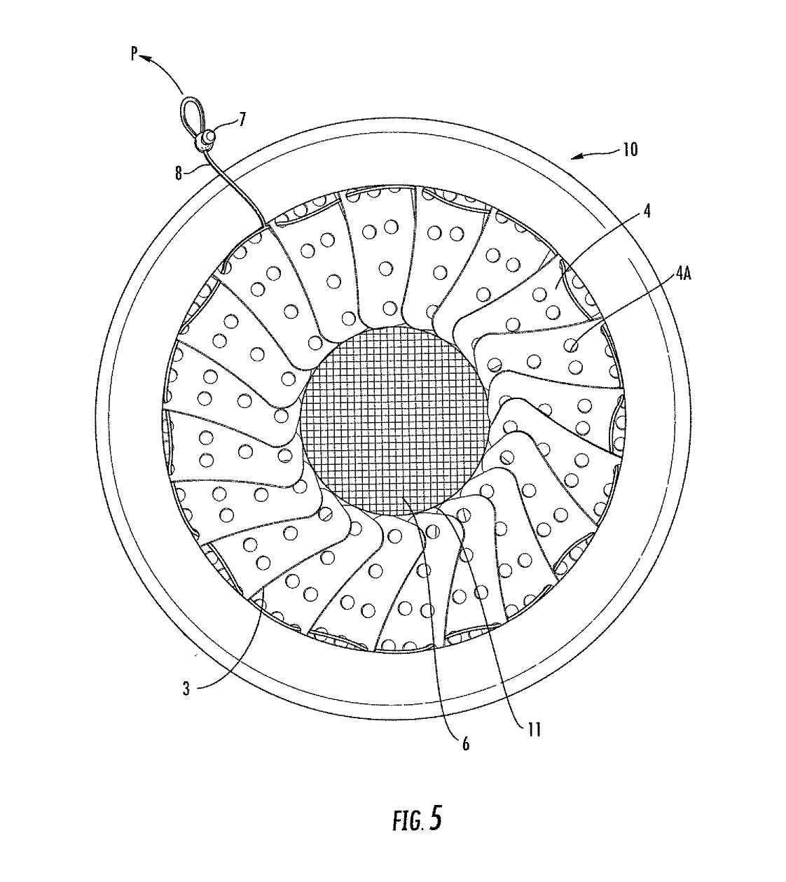

FIG. 2 is a top pictographic view of the net system of FIG. 1 in a sink or catchment basin during a use relative to a central portion for draining.

FIG. 3 is a side view of an alternative net system according to another aspect of the present invention showing the net system additionally including a basket portion.

FIG. 4 is a partial cross sectional view along Section IV-IV in FIG. 2 noting the securing of debris during a use and the motion of a draw loop motion P.

FIG. 5 is a top plan pictographic view of an alternative embodiment of the present system including at least one semi-rigid or rigid leaf section and an optional central basket portion operably integrated for a use therewith relative to a catchment basin.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘secure’ or ‘connect’ or ‘couple’ and similar terms do not necessarily denote direct and immediate connections, but may also include connections through intermediate elements or devices. For purposes of convenience and clarity only, directional (up/down, etc.) or motional (pull/push/forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto,

Various operations may be described as multiple discrete operations in turn, in a manner that may be helpful in understanding embodiments of the present invention; however, the order of description should not be construed to imply that these operations are order dependent.

Referring now to FIGS. 1-5, a straining and transport system 10 includes a net system 9 having an outer perimeter. It will be understood that net system 9 is readily flexible, may be formed from fibers, strings, netting or other materials and may adaptively be formed from non-fibrous silicone in a molded-netting manner, such that in any form net system 9 contains a plurality of openings and draining holes.

Interwoven about the perimeter region of straining and transport system 10 is a draw loop 8 entrained and intermingled about the perimeter region and slidable relative thereto so as to, when a pulling force P is applied to draw loop 8 the outer perimeter region of straining and transport system 10 is gathered relatively together about a central region or central portion 11 for removal of debris 30 from a supporting sink or catchment basin 20 having a drain opening 21.

As will be understood by those of skill in the art, a sink or catchment basin 20 may receive, during processing of materials, food parts 5, egg shells, bread scraps, or other preparation debris collectively to be understood as debris 30 that require removal and ready transport away from sink or catchment basin 20.

So that straining and transport system 10, constructed from flexible material 9 may be readily supported for convenience on the upper walls of sink or catchment basin 20, a plurality of suction cups and hook or securing systems 3 are positioned about the outer perimeter of the sink side wall (see FIG. 4). As will be understood, the suction cups 3A in securing system 3 includes operates with a hook member 3B for removably engaging with openings in net material 9 to provide a lift-away ease when providing pulling force P to draw loop 8.

It will therefore be understood, that straining and transport system 10 is readily removed from a supporting sink or catchment basin 20 for transport to a recycling bin for removal of debris 30 after loosening. It will also be understood, that draw loop 8 may include a pull locking member 7 (FIG. 1).

In a modified alternative embodiment net material portion 9 may include an adaptive mesh basket portion 6 proximate central portion 11. Mesh basket portion would be of a fin and metal or semi-rigid construction allowing water to pass through but retainment of debris 30. It is envisioned, that mesh basket portion 6 would fit within or into drain opening 21 in sink or catch basin 20. Net material portion 9 would be secured to mesh basket portion 6 in any convenient and flexible manner such as interweaving, adhesion by molding, co-molding, or otherwise as would be known to those of skill in the arts of production assembly.

In another alternative embodiment, net material 9 in straining and transport system 10 may further include or be formed with a plurality of metal mesh leaf portions 4 (FIG. 5) having a plurality of draining holes 4A for water passage therethrough. In central portion 11, it is proposed that mesh basket portion 6 or other netting material 9 may be provided to join respective mesh leaf portions 4 and provide a draining through to drain opening 21 (shown in FIGS. 2 and 4). It will be noted that respective leaf portions 4 may be co-joined or co-secured with leaf hinge constructions 3 so that during a drawing of draw loop 8 along pull direction P with a pulling force, that respective leaf portions 4 may be drawn together for securing debris 30 (not shown in FIG. 50) for later transport for recycling or disposal.

Those of skill in the art will also recognize that the disclosure and discussion herein of straining and transport system 10 also includes the disclosure of the same a method of manufacturing, using, and deployment. So that the disclosure herein additionally includes the disclosure of a method of manufacturing system 10, a method of using system 10, and a method of deployment for system 10 without the need for additional flow-or-action-step discussions.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A straining and transport system comprising:
a net material member having an outer perimeter boundary;
a draw loop system entrained in said net material member proximate said outer perimeter boundary, and
said draw loop system being slidably therealong relative to said net material member whereby during a pulling use of said draw loop system said entrained net material is gathered relative to a central portion thereof.

2. The straining and transport system, according to claim 1, further comprising:
a plurality of supporting structures removably engaging selected portions of said net material relative to upright walls of an external catchment basin so that during said pulling use, said net material is removable relative to said upright walls for easy transport.

3. The straining and transport system, according to claim 2, further comprising:
said supporting structures including suction cup members operable for a suction-based securement to said upright walls.

4. The straining and transport system, according to claim 3, further comprising:
a respective engagement hook member extending from each said suction cup member for removably engaging with said net material.

5. The straining and transport system, according to claim 1, wherein:
said net material is at least one of a woven material and a molded material; and
said net material includes a plurality of small openings operable to allow a fluid passage and retainment of debris prior to removal from said external catchment basin.

6. The straining and transport system, according to claim 2, further comprising:
a mesh basket portion proximate said central portion of said net material, whereby during said use said mesh basket portion is removably retained proximate a draining opening in said catchment basin.

7. The straining and transport system, according to claim 2, further comprising:
a plurality of leaf portions proximate replacing said net material and flexible therebetween during said use.

8. The straining and transport system, according to claim 7, further comprising:
a mesh basket portion proximate said central portion of said plurality of leaf portions, whereby during said use said mesh basket portion is removably retained proximate a draining opening in said catchment basin.

9. A method for straining and transporting waste members relative to a catchment basin, comprising the steps of:
providing a net material member having an outer perimeter boundary;
providing a draw loop system entrained in said net material member proximate said outer perimeter boundary;
said draw loop system being slidably therealong relative to said net material member during a pulling use whereby during said pulling use of said draw loop system said entrained net material is gathered relative to a central portion thereof;
securing a plurality of removable supporting structures and engaging selected portions of said net material on said removable supporting structures relative to upright walls of said external catchment basin so that during said pulling use, said net material is removable relative to said upright walls for easy transport; whereby
said supporting structures further include suction cup members operable for a suction-based securement to said upright walls; and
providing respective engagement hook member extending from each said suction cup member for removably engaging with said net material.

10. The method for straining and transporting waste members relative to a catchment basin, according to claim 9, further comprising the steps of:
providing said net material as one of a woven material and a molded material; and
said net material includes a plurality of small openings operable to allow a fluid passage and retainment of external debris prior to removal from said external catchment basin.

11. The method for straining and transporting waste members relative to a catchment basin, according to claim 9, further comprising the steps of:
providing a mesh basket portion proximate said central portion of said net material, whereby during said use said mesh basket portion is removably retained proximate a draining opening in said catchment basin.
